(19) United States
(12) Patent Application Publication
(10) Pub. No.: US 2012/0173145 A1
(43) Pub. Date: Jul. 5, 2012

(54) NAVIGATION DEVICE, CONTROL METHOD, PROGRAM, AND STORAGE MEDIUM

(75) Inventors: Masayoshi Suzuki, Tsurugashima (JP); Tetsuro Shimamura, Fujimino (JP)

(73) Assignees: PIONEER SYSTEM TECHNOLOGIES CORPORATION, Miyagi (JP); PIONEER CORPORATION, Kanagawa (JP)

(21) Appl. No.: 13/394,300

(22) PCT Filed: Sep. 9, 2009
(86) PCT No.: PCT/JP2009/065725

§ 371 Date: Mar. 5, 2012

(51) Int. Cl. G01C 21/36

(52) U.S. Cl. 701/533; 701/400

(57) ABSTRACT

A determination unit determines whether or not the vehicle is running on a road known by a user. A mode setting unit sets an output mode to a known road running mode in a case where the determination unit determines that the vehicle is running on the known road, and sets the output mode to a normal mode in a case where the determination unit determines that the vehicle is not running on the known road. A function suppressing unit suppresses the interrupt function in the known road running mode. A valuable information presenting unit displays, in the known road running mode, some or all valuable information in a larger scale compared to the normal mode among plural piece of information displayed in the normal mode, and/or which displays other valuable information which is not displayed in the normal mode.

### TECHNICAL FIELD

The present invention relates to a control technology of presenting information to a user by a navigation device.

### BACKGROUND TECHNIQUE

Conventionally, there is a technique for a car navigation device which restricts an audio guide in an area where the user knows road conditions well such as his or her neighborhood. For example, Patent Reference-1 discloses a technique which restricts an audio guide according to the decrease of the distance from the present location to his or her house, which is the destination, when the house is set as the destination.

Patent Reference-1
Japanese Patent Application Laid-open under No. 2006-226956

### DISCLOSURE OF INVENTION

### Problem to be Solved by the Invention

In contrast, there exists necessary information for a user even when the user drives the vehicle in an area where the user knows road conditions well such as his or her neighborhood. In Patent Reference-1, the above problem is not considered at all.

The above is an example of the problem to be solved by the present invention. An object of the present invention is to provide a navigation device which restrict unnecessary functions and which actively presents valuable information to the user at the time when the user drives the vehicle in an area where the user knows road conditions well.

### Means for Solving the Problem

The invention according to claim 1 is a navigation device mounted on a vehicle, including: a determination unit which determines whether or not the vehicle is running on a road known by a user; a mode setting unit which sets an output mode to a known road running mode in a case where the determination unit determines that the vehicle is running on the known road, and which sets the output mode to a normal mode in a case where the determination unit determines that the vehicle is not running on the known road; a function suppressing unit which allows an interrupt function associated with a route guide in the normal mode, and which suppresses the interrupt function in the known road running mode; and a valuable information presenting unit which displays, in the known road running mode, some or all valuable information in a larger scale compared to the normal mode among plural piece of information displayed in the normal mode, and/or which displays other valuable information which is not displayed in the normal mode.

The invention according to claim 6 is a control method executed by a navigation device mounted on a vehicle, including: a determination process which determines whether or not the vehicle is running on a road known by a user; a mode setting process which sets an output mode to a known road running mode in a case where the determination process determines that the vehicle is running on the known road, and which sets the output mode to a normal mode in a case where the determination process determines that the vehicle is not running on the known road; a function suppressing process which allows an interrupt function associated with a route guide in the normal mode, and which suppresses the interrupt function in the known road running mode; and a valuable information presenting process which displays, in the known road running mode, some or all valuable information in a larger scale compared to the normal mode among plural piece of information displayed in the normal mode, and/or which displays other valuable information which is not displayed in the normal mode.

The invention according to claim 7 is a program executed by a navigation device mounted on a vehicle, making the navigation device function as: a determination unit which determines whether or not the vehicle is running on a road known by a user; a mode setting unit which sets an output mode to a known road running mode in a case where the determination unit determines that the vehicle is running on the known road, and which sets the output mode to a normal mode in a case where the determination unit determines that the vehicle is not running on the known road; a function suppressing unit which allows an interrupt function associated with a route guide in the normal mode, and which suppresses the interrupt function in the known road running mode; and a valuable information presenting unit which displays, in the known road running mode, some or all valuable information in a larger scale compared to the normal mode among plural piece of information displayed in the normal mode, and/or which displays other valuable information which is not displayed in the normal mode.

### BRIEF DESCRIPTION OF THE DRAWINGS

FIG. 1 is one example of a schematic configuration of the navigation device according to the embodiment.

FIG. 2 is one example of the functional block of the navigation device according to the embodiment.

FIGS. 3A and 3B are examples of the screen images according to the normal mode.

FIG. 4 is one example of the screen image according to the known road running mode.

FIG. 5 is one example of the flowchart showing a procedure of the process according to the embodiment.

### DETAILED DESCRIPTION OF THE PREFERRED EMBODIMENTS

According to one aspect of the present invention, there is provided a navigation device mounted on a vehicle, including: a determination unit which determines whether or not the vehicle is running on a road known by a user; a mode setting unit which sets an output mode to a known road running mode in a case where the determination unit determines that the vehicle is running on the known road, and which sets the output mode to a normal mode in a case where the determination unit determines that the vehicle is not running on the known road; a function suppressing unit which allows an interrupt function associated with a route guide in the normal mode, and which suppresses the interrupt function in the known road running mode; and a valuable information presenting unit which displays, in the known road running mode, some or all valuable information in a larger scale compared to the normal mode among plural piece of information displayed in the normal mode, and/or which displays other valuable information which is not displayed in the normal mode.

The above navigation device is mounted on a vehicle, and includes a determination unit, a mode setting unit, a function suppressing unit, and a valuable information presenting unit. Here, the navigation device may be not only a static navigation device but also a portable navigation device such as PND (Personal Navigation Device). The determination unit determines whether or not the vehicle is running on a road known by a user. Here, for example, the determination unit may determines whether or not the vehicle is running on the known road based on an explicit input by the user, or may automatically determines that roads existing in the vicinity of a registered point set by the user in advance. The term “known road” herein indicates a road (a route) where the user can drive the vehicle toward an intended point without a navigation function such as a route guide by an audio guide or a screen image or without a map display in the vicinity of the present location presented by the navigation device. The term “user” herein includes not only the driver of the vehicle but also passengers in the vehicle. The mode setting unit sets an output mode to a known road running mode in a case where the determination unit determines that the vehicle is running on the known road, and sets the output mode to a normal mode in a case where the determination unit determines that the vehicle is not running on the known road. The term “known road running mode” herein indicates an output mode applied at the time when the vehicle is running on the known road, and includes not only functions of the normal mode but also functions executed by the valuable information presenting unit. The function suppressing unit allows an interrupt function associated with a route guide in the normal mode, and which suppresses the interrupt function in the known road running mode. The term “interrupt function associated with a route guide” herein includes an enlarged view of an intersection, where the vehicle should turn right or left next, at the time when the vehicle comes close to the intersection, and an audio guide concerning the turn direction at the intersection. The valuable information presenting unit displays, in the known road running mode, some or all valuable information in a larger scale compared to the normal mode among plural piece of information displayed in the normal mode, and/or it displays other valuable information which is not displayed in the normal mode. Namely, the term “valuable information” herein indicates not only predetermined information which the user needs even at the time of running on a known road similarly to the time of running on an unfamiliar road, but also predetermined information which the user especially needs at the time of running on the known road. Concretely, the valuable information may be properly set in advance by experimental trials or may be set by an explicit designation by the user. In this way, by suppressing unnecessary navigation function and actively displaying necessary information at the time when the vehicle is running on the known road, the navigation device can improve the user-friendliness.

In one mode of the navigation device, the determination unit determines that any road existing in an area designated based on an external input is the known road. The term “external input” herein indicates an input based on the operation by the user. Thereby, the navigation device can precisely determine whether or not the vehicle is running on the road known by the user.

In another mode of the navigation device, the determination unit determines that any road existing within a predetermined distance from a registered point set in advance based on an external input is the known road. The term “registered point” herein includes not only a point registered in order to let the determination unit determine whether or not it is the known road, but also a point registered in order to easily set the destination which is used for the purpose of the route guide, for example. The above-mentioned predetermined distance is set to a proper value by experimental trials in advance, and stored in a memory of the navigation device. Thereby, the navigation device can precisely determine whether it is the road known by the user or not without setting or operation by the user for the purpose of determining whether or not it is the known road.

In another mode of the navigation device, the determination unit determines whether or not the vehicle is running on the known road based on a driving record of the vehicle. Thereby, the navigation device can also precisely determine whether it is the road known by the user or not without setting or operation by the user for the purpose of determining whether or not it is the known road.

In another mode of the navigation device, the valuable information presenting unit sets at least one of an expected time of arrival at a destination or a transit point, a departure time, an elapsed time since a departure, weather at the destination or the transit point, traffic information, and information of an event held at a present location, the destination, or the transit point to the valuable information. The term “destination” herein indicates a destination which the user sets to the navigation device, and “transit point” herein indicates a point which the user sets as a point for stopping off on the way to the destination. The term “departure time” herein indicates a time when the vehicle is initiated or when the destination or the transit point is set. The term “traffic information” includes traffic jam information of roads in the vicinity and information of a departure time of an airplane. The navigation device obtains the above-mentioned information via telecommunications or broadcast or obtains it by calculating by itself, and enlarges and displays it or newly display it. Thereby, the navigation device can further improve the user-friendliness.

According to another aspect of the present invention, there is provided a control method executed by a navigation device mounted on a vehicle, including: a determination process which determines whether or not the vehicle is running on a road known by a user; a mode setting process which sets an output mode to a known road running mode in a case where the determination process determines that the vehicle is running on the known road, and which sets the output mode to a normal mode in a case where the determination process determines that the vehicle is not running on the known road; a function suppressing process which allows an interrupt function associated with a route guide in the normal mode, and which suppresses the interrupt function in the known road running mode; and a valuable information presenting process which displays, in the known road running mode, some or all valuable information in a larger scale compared to the normal mode among plural piece of information displayed in the normal mode, and/or which displays other valuable information which is not displayed in the normal mode. By executing the above-mentioned method, the navigation device can actively display necessary information while suppressing unnecessary navigation function at the time when the vehicle is running on a road known by the user thereby to improve the user-friendliness.

According to still another aspect of the present invention, there is provided a program executed by a navigation device mounted on a vehicle, making the navigation device function as: a determination unit which determines whether or not the vehicle is running on a road known by a user; a mode setting unit which sets an output mode to a known road running mode in a case where the determination unit determines that the vehicle is running on the known road, and which sets the output mode to a normal mode in a case where the determination unit determines that the vehicle is not running on the known road; a function suppressing unit which allows an interrupt function associated with a route guide in the normal mode, and which suppresses the interrupt function in the known road running mode; and a valuable information presenting unit which displays, in the known road running mode, some or all valuable information in a larger scale compared to the normal mode among plural piece of information displayed in the normal mode, and/or which displays other valuable information which is not displayed in the normal mode. By the above program being installed and executed, the navigation device can actively display necessary information while suppressing unnecessary navigation function at the time when the vehicle is running on a road known by the user thereby to improve the user-friendliness. In a preferred example, the above program is stored in a recording medium.

### Embodiment

Now, a preferred embodiment of the present invention will be described below with reference to the attached drawings. Hereinafter, after the schematic configuration of the navigation device in the present invention is explained, the control method executed by the navigation device, the display example thereof, and the process flow will be described in order. After that, each modification relevant to the embodiment will be described in addition.

[Schematic Configuration]

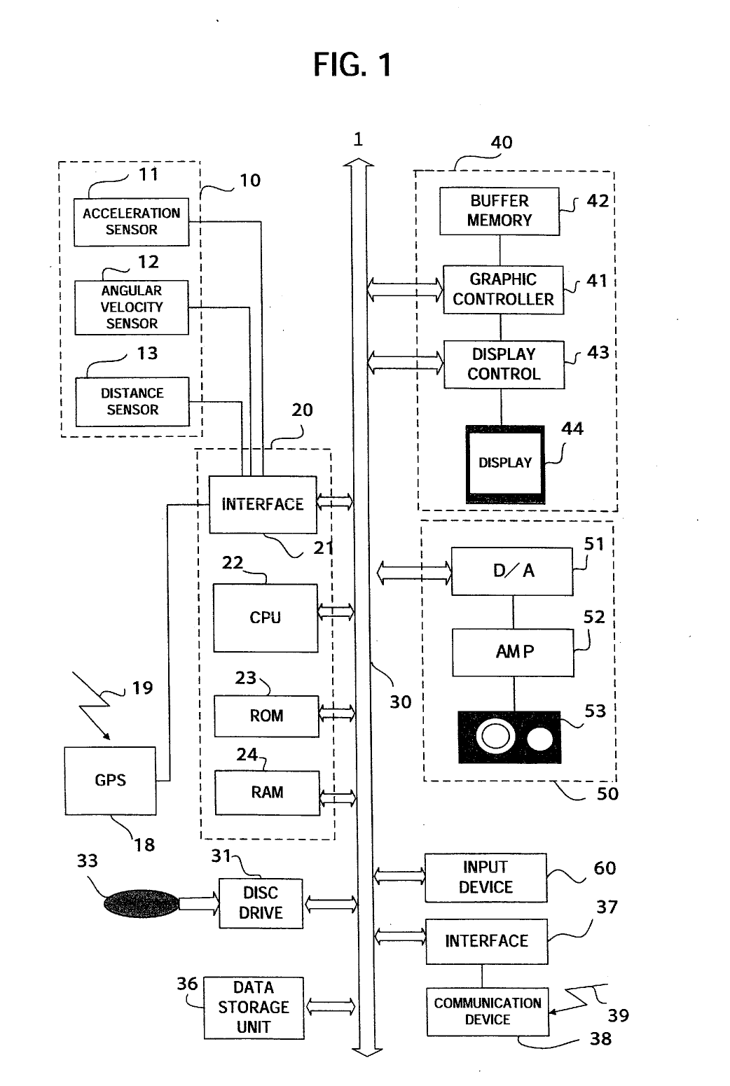

FIG. 1 shows a configuration of a navigation device 1. As shown in FIG. 1, the navigation device 1 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position (hereinafter referred to as “present location”) of the vehicle from longitude and latitude information.

The system controller 20 includes an interface 21, a CPU (Central Processing Unit) 22, a ROM (Read Only Memory) 23 and a RAM (Random Access Memory) 24, and controls the entire navigation device 1.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22. It is noted that a concrete processing executed by each of the above-mentioned components of the system controller 20 will be described in detail in the below section “Control Method”.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD. The data storage unit 36 includes HDD, for example, and stores various kinds of data used for a navigation process such as map data. The communication device 38 includes an FM tuner, a beacon receiver, a mobile phone and a dedicated communication card, for example, and obtains information (hereinafter referred to as “VICS information”) delivered from a VICS (Vehicle Information Communication System) center by the electric wave 39. The communication interface 37 executes the interface operation of the communication device 38 to input the VICS information into the system controller 20.

The display unit 40 displays various kinds of display data on a display device such as a display under the control of the system controller 20. Concretely, the system controller 20 reads the map data from the data storage unit 36. The display unit 40 displays the map data read from the data storage unit 36 by the system controller 20 on its display screen. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A (Digital to Analog) converter 51 for executing D/A conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 is in a touch panel system, a touch panel provided on the display screen of the display 44 functions as the input device 60, too.

It is noted that the CPU 22 shown in FIG. 1 functions as a determination unit, a mode setting unit, a function suppressing unit and a valuable information presenting unit according to the present invention.

In the following explanation, the term “equipped vehicle” herein indicates a vehicle equipped with the navigation device 1. The term “user” includes not only a driver in the equipped vehicle but also a passenger in the equipped vehicle. The term “destination” herein indicates a destination which the user sets to the navigation device 1, and “transit point” herein indicates a point which the user sets as a point for stopping off on the way to the destination. The term “destination equivalent” indicates the destination and the transit point if they are not distinguished from each other.

[Control Method]

Next, a description will be given of the processing executed by the system controller 20. Summarily, when the equipped vehicle is running on a road (hereinafter simply referred to as “known road”) which the user previously knows, the system controller 20 suppresses functions which are unnecessary for the user and actively displays information which is valuable to the user. Thereby, the system controller 20 properly executes the output according to whether or not the user knows the road, and improves the user-friendliness.

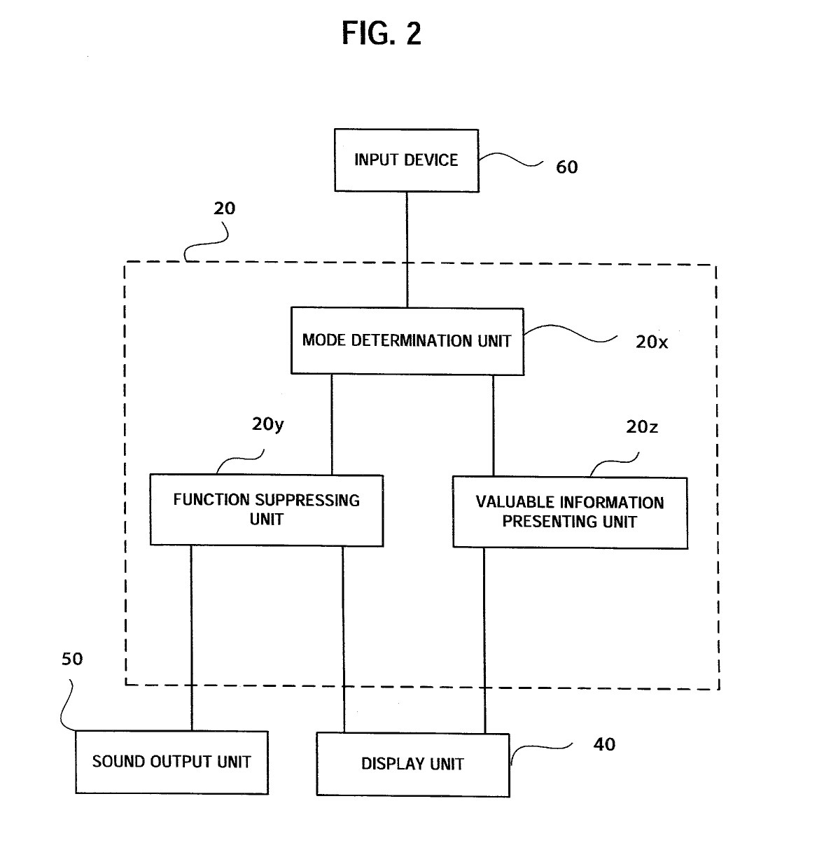

The process thereof will be concretely described with reference to FIG. 2. FIG. 2 is one example showing functional blocks of the system controller 20. As shown in FIG. 2, the system controller 20 includes a mode determination unit 20x, a function suppressing unit 20y, and a valuable information presenting unit 20z. The processing executed by each of the above-mentioned components will be described. In the following explanation, it is assumed that the navigation device 1 has already accepted setting of a predetermined destination equivalent and it has already started the route guide.

First, the processing executed by the mode determination unit 20x will be described. Based on the input from the user to the input device 60, the mode determination unit 20x determines whether or not the equipped vehicle is running on the known road, and according to the determination result, it determines the mode (hereinafter simply referred to as “output mode”) of the audio output and the screen output executed by the navigation device 1. Hereinafter, the output mode applied at a time when the equipped vehicle is running on the known road is referred to as “known road running mode”, and the output mode in other cases is referred to as “normal mode”. The known road running mode is an output mode including the functions, which are executed by the function suppressing unit 20y and the valuable information presenting unit 20z described below, besides the function of the normal mode. The mode determination unit 20x supplies the function suppressing unit 20y and the valuable information presenting unit 20z with information (hereinafter simply referred to as “mode information”) which indicates whether the output mode is the known road running mode or the normal mode.

Here, a supplementary description will be given of the method which determines whether or not the vehicle is running on the known road on the basis of the user input by citing a concrete example. For example, the mode determination unit 20x accepts the instruction indicating that the output mode should be changed to the known road running mode or the instruction indicating that the output mode should be changed to the normal mode from the user via the input device 60. In another example, the mode determination unit 20x lets the user designate the known road or the area including the known road by the input device 60 in advance. For example, by displaying a map of the vicinity of user's home or the registered point, the mode determination unit 20x lets the user designate the known road or the area including the known road, and it stores the input information thereof on the data storage unit 36. After that, based on the known road or the area including the known road (hereinafter their general term is referred to as “designated area”) designated by the user and the information of the present location supplied from the GPS receiver 18, the mode determination unit 20x determines whether or not the equipped vehicle is running on the known road. Then, when the mode determination unit 20x determines that the equipped vehicle is in the designated area, it sets the output mode to the known road running mode. In contrast, when the mode determination unit 20x determines that the equipped vehicle is not in the designated area, it sets the output mode to the normal mode. As indicated in these examples, the mode determination unit 20x can properly set the output mode based on the user input.

Next, a description will be given of the processing executed by the function suppressing unit 20y. The function suppressing unit 20y suppresses unnecessary functions when the output mode is the known road running mode. Concretely, in case of the known road running mode, the function suppressing unit 20y suppresses the interrupt processing to the display unit 40 and the sound output unit 50 associated with the navigation function. In this way, by suppressing the unnecessary functions while the vehicle is running on the known road, the function suppressing unit 20y can suppress the deterioration of the usability and the occurrence of the discomfort feeling of the user due to the unnecessary audio guide and the unnecessary automatic changeover of the screen.

Here, a concrete description will be given of the interrupt processing to the display unit 40 and the sound output unit 50 associated with the navigation function. First, the interrupt processing to the display unit 40 associated with the navigation function is a function to display, in a case where an intersection (hereinafter referred to as “navigation point”) targeted for turning next becomes close within a predetermined distance (hereinafter referred to as “distance Dth”) at the time of the route guide until the arrival at the destination equivalent, an enlarged view (hereinafter referred to as “enlarged navigation point view”) of the navigation point, for example. The above-mentioned distance Dth is set to a proper value in advance by experimental trials. In this case, the display unit 40 displays a map image including the enlarged navigation point view instead of displaying a map image of the present location or an information image (audio visual image) concerning the audio visual content under reproduction. The explanation thereof will be further described in the section “Display Example”. Next, the interrupt processing to the sound output unit 50 associated with the navigation function is a function of the audio guide concerning the navigation point in the case where the navigation point becomes close within the distance Dth, and a function to mute or lower volume of music under reproduction in response to the audio guide, for example. In the case where the output mode is the known road running mode, by suppressing the above-mentioned interrupt processing, the function suppressing unit 20y can suppress the break of music under reproduction, the occurrence of the discomfort feeling of the user due to cancellation of the audio visual image, and the deterioration of the usability.

Next, the processing executed by the valuable information presenting unit 20z will be described below. When the output mode is the known road running mode and a map image is displayed, the valuable information presenting unit 20z limits the display area of the map image unnecessary for the user, and it also enlarges and displays information (hereinafter referred to as “valuable information”) valuable to the user or newly displays it on the display unit 40.

The term “valuable information” herein indicates information which the user needs even at the time of running on the known road similarly to the time of running on an unfamiliar road, and information which the user especially needs at the time of running on the known road. For example, the valuable information is one or more than one piece of information selected from a distance to the destination equivalent, an expected time of arrival to the destination equivalent which the system controller 20 calculates, a departure time, an elapsed time from the departure time to the present time, weather information at the destination equivalent, traffic jam information or traffic information such as a flight status of airplanes, information of an event held at the present location or the destination equivalent, and recommended information for the user.

As described above, by actively displaying the valuable information at the time of running on the known road, the valuable information presenting unit 20z can improve the user-friendliness. It is noted that a concrete description of the valuable information and the display method thereof will be given in the next section “Display Example”.

[Display Example]

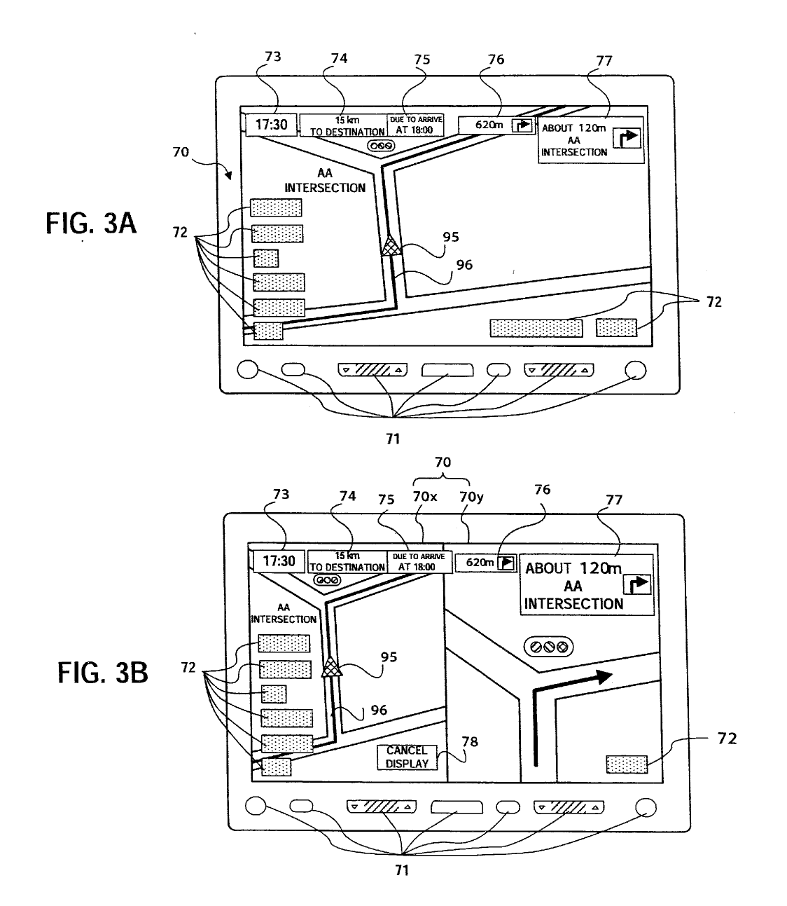

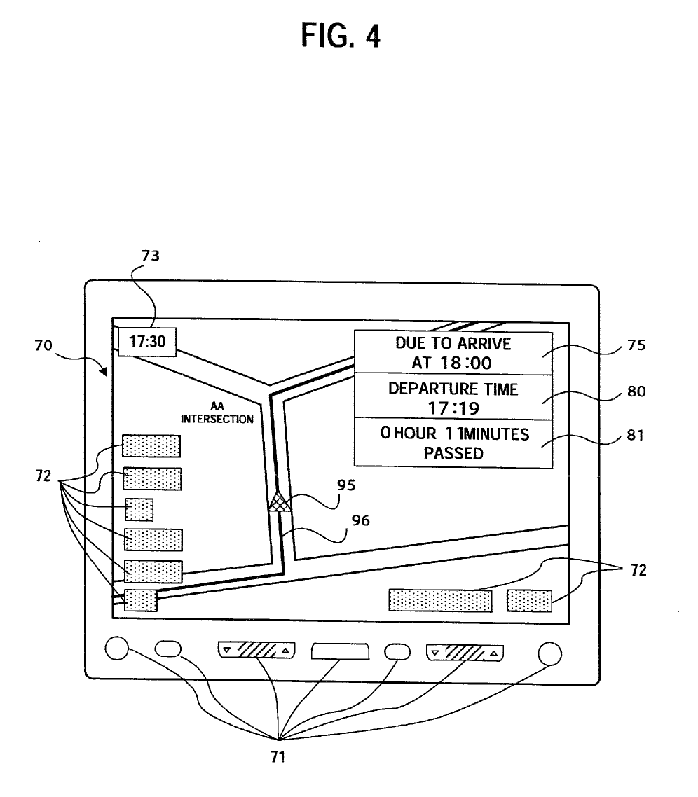

Next, a description will be given of the screen image outputted by the display unit 40 according to the embodiment with reference to FIGS. 3A, 3B and 4. In the following explanation, it is assumed that the navigation device 1 accepts the input by the touch panel as one example.

FIG. 3A shows a display example outputted at the time of route guide in the normal mode. The display example shown in FIG. 3A includes a screen image display unit 70 and buttons 71. The screen image display unit 70 includes buttons 72, a present time display part 73, a destination distance display part 74, an expected-time-of-arrival display part 75, navigation-point information display parts 76 and 77, a present location display 95, and a guided route 96.

The buttons 71 are buttons provided on the frame of the navigation device 1, and accept various inputs by depression by the user. The buttons 72 are buttons displayed on the screen image display unit 70, and accept various inputs by depression on the touch panel by the user. The present time display part 73 is a display area showing the present time. The destination distance display part 74 is a display area showing the distance from the present location to the destination equivalent. The expected-time-of-arrival display part 75 is a display area showing an arrival time to the destination equivalent calculated by the system controller 20. The navigation-point information display part 76 is a display area showing information of the navigation point after the next navigation point on the guided route 96 described below. The navigation-point information display part 77 is a display area showing information of the next navigation point on the guided route 96. The present location display 95 is an icon showing the present location of the equipped vehicle on the displayed map. The guided route 96 shows the route which the navigation device 1 guides until the vehicle arrives at the destination equivalent.

As shown in FIG. 3A, in the normal mode, the system controller 20 displays the present time display area 73, the destination distance display unit 74, the expected-time-of-arrival display part 75, and the navigation-point information display parts 76 and 77 as information necessary for assisting the drive. The system controller 20 also displays the above-mentioned information on the top edge of the screen image display unit 70 to such an extent that the display of the guided route 96 and other map display are not disturbed.

FIG. 3B shows a display example in a case where the interrupt processing associated with the navigation function occurs in the normal mode. The screen image display unit 70 shown in FIG. 3B has a display area 70x, where the map display is executed, on its left half, and has a display area 70y showing the enlarged navigation point view on its right half. The screen image display unit 70 shown in FIG. 3B also includes the button 78 for accepting cancellation of the enlarged view displayed on the display area 70y.

As shown in FIG. 3B, in the normal mode, the system controller 20 displays the enlarged navigation point view if needed when the distance to the next navigation point becomes within the distance Dth. The system controller 20 also informs the user of the distance to the navigation point and the turning direction by the audio guide. Thereby, the system controller 20 can properly guide the user even when the vehicle runs on a road the user does not know.

FIG. 4 shows a display example outputted in case of the known road running mode. In FIG. 4, the system controller 20 displays the expected-time-of-arrival display part 75 in a larger scale, and it also newly displays a departure time display part 80 which displays the departure time, and a lapse time display part 81 which shows an elapsed time since the departure. The system controller 20 does not display the destination distance display part 74 and the navigation-point information display parts 76 and 77 as unnecessary information.

In this way, in the known road running mode, the system controller 20 displays in a larger scale or newly displays the expected-time-of-arrival display part 75, the departure time display part 80, and the lapse time display part 81 as the valuable information, and it does not display the navigation-point information display parts 76 and 77 which are regarded as unnecessary information at the time of running on the known road. In the known road running mode, the system controller 20 suppresses interrupt display of the enlarged navigation point view as shown in FIG. 3B, and it also suppresses the output of the audio guide associated with the interrupt display. In this way, by suppressing unnecessary navigation function and actively displaying necessary information at the time when the equipped vehicle is running on the known road, the system controller 20 can improve the user-friendliness.

[Process Flow]

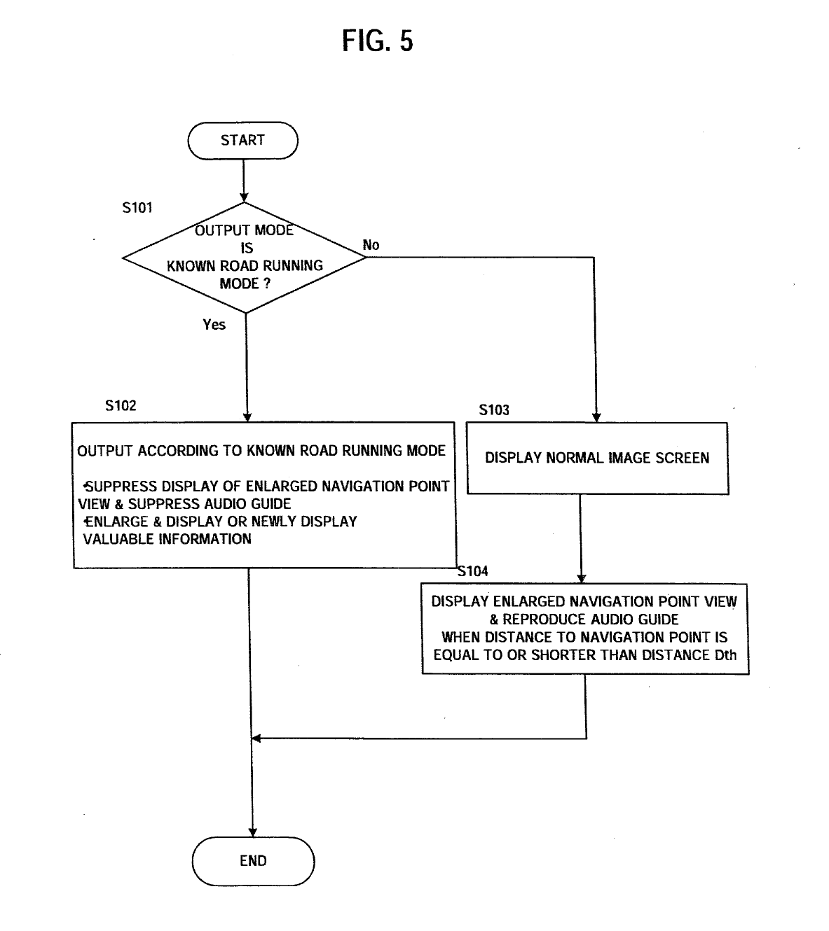

Next, a description will be given of a procedure of the processing executed by the system controller 20 according to the embodiment with reference to FIG. 5. FIG. 5 is an example of a flowchart showing the procedure of the processing executed by the system controller 20 according to the embodiment. The system controller 20 repeatedly executes the processing of the flowchart shown in FIG. 5 in a predetermined cycle.

First, the system controller 20 determines whether or not the output mode is the known road running mode (step S101). Concretely, by determining whether or not the equipped vehicle is running on the known road based on the input from the input device 60, the system controller 20 determines whether or not the output mode is the known road running mode.

When the output mode is known road running mode (step S101; Yes), i.e., when the system controller 20 determines that the equipped vehicle is running on the known road, it executes the output according to the known road running mode (step S102). Concretely, the system controller 20 suppresses the display of enlarged navigation point view, and it suppresses the audio guide. The system controller 20 also enlarges and displays the valuable information or newly displays it. For example, the system controller 20 enlarges and displays the expected time of arrival as shown in FIG. 4. Besides, the system controller 20 newly displays the departure time and the elapsed time since the departure as shown in FIG. 4. In this way, by suppressing unnecessary functions and actively presenting necessary information at the time when the equipped vehicle is running on the known road, the system controller 20 can improve the user-friendliness.

When the output mode is not the known road running mode (step S101; No), i.e., when the output mode is the normal mode, the system controller 20 displays a normal screen image (step S103). In other words, the system controller 20 determines that the equipped vehicle is not running on the known road. Then, the system controller 20 outputs a screen image such as the screen image shown in FIG. 3A, for example. Namely, to such an extent that the map display is not disturbed, the system controller 20 displays information for supporting the drive such as the distance to the destination and the expected time of arrival on the top edge of the screen image display unit 70.

Next, the system controller 20 displays the enlarged navigation point view and reproduces the audio guide when the distance to the navigation point is equal to or shorter than the distance Dth (step S104). Namely, in this case, as shown in FIG. 3B, the system controller 20 displays the enlarged view of the intersection which the vehicle passes next and performs the audio guide with respect to the distance to the intersection and the turning direction.

As described above, the navigation device is mounted on a vehicle, and includes a determination unit, a mode setting unit, a function suppressing unit, and a valuable information presenting unit. The determination unit determines whether or not the vehicle is running on a road known by a user. The mode setting unit sets an output mode to a known road running mode in a case where the determination unit determines that the vehicle is running on the known road, and sets the output mode to a normal mode in a case where the determination unit determines that the vehicle is not running on the known road. The function suppressing unit allows an interrupt function associated with a route guide in the normal mode, and which suppresses the interrupt function in the known road running mode. The valuable information presenting unit displays, in the known road running mode, some valuable information, which is displayed in the normal mode and which is also valuable in case of the known road running mode, in a larger scale compared to the normal mode, and/or it displays valuable information which is not displayed in the normal mode and which is valuable in case of the known road running mode. In this way, by suppressing unnecessary navigation function and actively displaying necessary information at the time when the vehicle is running on a road known by the user, the navigation device can improve the user-friendliness.

[Modification]

Each modification of the embodiment will be described below. Each modification can be applied to the above-mentioned embodiment in combination.

(First Modification)

In the explanation with respect to FIG. 2, the mode determination unit 20x determines the output mode based on the input by the user, i.e., based on the designated area inputted by the user or the selection of the output mode by the user. However, the method to which the present invention can be applied is not limited to the method. Instead of this, or in addition to this, the mode determination unit 20x may automatically determine the output mode regardless of the above-mentioned input by the user.

The concrete description thereof will be given blow. For example, the mode determination unit 20x may regards roads at registered points set by the user in advance for the purpose of a simple setting of the destination and roads at the vicinities of the registered points as the known roads. In this case, the mode determination unit 20x automatically sets the output mode to the known road running mode at any place within a predetermined distance from the registered point, and it sets the output mode to the normal mode at anyplace distant from the registered points by longer than the predetermined distance, for example. The above-mentioned distance is set to a proper value by experimental trials.

In another example, based on the driving record stored in the data storage unit 36, the mode determination unit 20x determines whether or not the equipped vehicle is running on the known road. Concretely, the mode determination unit 20x regards any road where the vehicle has ever run a predetermined number of times or more times according to the driving record as the known road, and it sets the output mode to the known road running mode at the time of running the road. In contrast, the mode determination unit 20x regards that any road where the vehicle has ever run less than the predetermined number of times according to the driving record is not the known road, and it sets the output mode to the normal mode at the time of running the road. In this case, the predetermined number of times is properly set to one or larger than one by experimental trials.

As described above, by automatically determining the output mode regardless of the input by the user, the mode determination unit 20x can further improve the user-friendliness.

(Second Modification)

In the explanation with respect to FIGS. 2 and 4, the system controller 20 enlarges and displays the valuable information or newly displays it when the destination equivalent is set and the root guide has already started. Besides this, in the case where the output mode is the known road running mode, the system controller 20 may enlarge and display the valuable information or newly display it even when the destination equivalent has not been set yet. In this case, for example, the system controller 20 displays an elapsed time (driving time) from the start of the engine until the present time, and/or information of an event held at the present location and other places. Thereby, the present invention can also be applied preferably.

(Third Modification)

In the explanation with respect to FIG. 2, valuable information presenting unit 20z enlarges and displays the valuable information or newly displays it only when a map image is displayed. Besides this, the valuable information presenting unit 20z may also display the valuable information when the map image is not displayed. In this case, the valuable information presenting unit 20z may let the user designate in advance whether or not the valuable information should be displayed at the time when the map image is not displayed, or it may display the valuable information on a smaller scale compared to the case where the map image is displayed so that the view of the currently-displayed screen image is not disturbed.

### INDUSTRIAL APPLICABILITY

This invention can be applied to a navigation device mounted on a vehicle, a PND (Personal Navigation device), and other terminal having a navigation function.

### BRIEF DESCRIPTION OF REFERENCE NUMBERS

1 Navigation device
10 Stand-alone position measurement device
18 GPS receiver
20 System controller
22 CPU
36 Data storage unit
38 Communication device
40 Display unit
44 Display

1-8. (canceled)

9. A navigation device comprising:
a setting unit which sets an output mode to one of a route guide mode in which information associated with a route guide is outputted when a destination is set and a route non-guide mode in which information not associated with the route guide is outputted when the destination is not set; and
an information output unit which outputs information, which is not outputted in the route guide mode and which is not associated with the route guide, when the output mode is the route non-guide mode,
wherein the information output unit outputs at least one of a departure time, process information since a departure, weather, traffic information and an event when the output mode is the route non-guide mode, and does not output the departure time, the process information since the departure, the weather, the traffic information and the event when the output mode is the route guide mode.

10. The navigation device according to claim 9,
wherein the information output unit includes a display unit which displays map information, information of a present location and information associated with the route guide in the route guide mode; and
wherein the information output unit outputs the information, which is not outputted in the route guide mode and which is not associated with the route guide, when the output mode is the route non-guide mode, even though the display unit is not displaying the map information.

11. A control method executed by a navigation device comprising:
a setting process which sets an output mode to one of a route guide mode in which information associated with a route guide is outputted when a destination is set and a route non-guide mode in which information not associated with the route guide is outputted when the destination is not set; and
an information output process which outputs information, which is not outputted in the route guide mode and which is not associated with the route guide, when the output mode is the route non-guide mode,
wherein the information output process outputs at least one of a departure time, process information since a departure, weather, traffic information and an event when the output mode is the route non-guide mode, and does not output the departure time, the process information since the departure, the weather, the traffic information and the event when the output mode is the route guide mode.

12. A program stored on a non-transitory storage medium and executed by a navigation device mounted on a vehicle, making the navigation device function as:
a setting unit which sets an output mode to one of a route guide mode in which information associated with a route guide is outputted when a destination is set and a route non-guide mode in which information not associated with the route guide is outputted when the destination is not set; and
an information output unit which outputs information, which is not outputted in the route guide mode and which is not associated with the route guide, when the output mode is the route non-guide mode,
wherein the information output unit outputs at least one of a departure time, process information since a departure, weather, traffic information and an event when the output mode is the route non-guide mode, and does not output the departure time, the process information since the departure, the weather, the traffic information and the event when the output mode is the route guide mode.
